(19) United States
(12) Patent Application Publication
(10) Pub. No.: US 2009/0273227 A1
(43) Pub. Date: Nov. 5, 2009

(54) DEEP LIP VEHICLE RIMS

(76) Inventor: Mark Tirado, Huntington Beach, CA (US)

Correspondence Address: CHRISTIE, PARKER & HALE, LLP, PO BOX 7068, PASADENA, CA, 91109-7068, US

(21) Appl. No.: 12/113,059

(22) Filed: Apr. 30, 2008

(51) Int. Cl. B60B 21/00

(52) U.S. Cl. 301/95.101; 301/63.101

(57) ABSTRACT

A vehicle wheel including a rim, a medial flange, a lateral flange, and an inner surface of the rim, wherein an extension portion of the inner surface extends beyond the medial flange.

### FIELD OF THE INVENTION

The present invention relates to a vehicle wheel and, more particularly, to a rim of a vehicle wheel having an axially extended inner surface.

### BACKGROUND

A growing trend in the motor vehicle industry is to produce wheels (or rims) that are aesthetically pleasing. Various wheels have been introduced to accomplish this goal, such as wheels having unique rim designs, unique spoke designs, unique color schemes and finishes, and other artistic designs.

### SUMMARY

An embodiment of the present invention provides a vehicle wheel of the type upon which a tire is mounted, the vehicle wheel including a rim body, a medial flange and a lateral flange together adapted to mount the tire to the rim body, and a rim extension extending medially from the rim body beyond the medial flange.

In other embodiments, the rim body and the rim extension may be integral to one another, or the rim body and the rim extension may be separate components.

The vehicle wheel will generally include a wheel face, which can be used to attach the wheel to the vehicle. Further, the wheel face may attach to the rim extension, or the wheel face may attach to the rim body.

A lip may extend radially inward from the rim extension, and the lip and the rim extension may be integral to one another or may be separate components.

Another embodiment of the present invention provides a vehicle wheel, of the type upon which a tire is mounted, the vehicle wheel including a rim body, a medial flange and a lateral flange together adapted to mount the tire to the rim body, a wheel face including at least one spoke, and a rim extension extending medially from the rim body beyond the medial flange.

A spoke or multiple spokes may attach to the rim body at the rim extension, or the wheel face may attach via at least one spoke to the rim extension and at least one spoke to the rim body.

The rim extension may extend from about ⅛ inch to about 6 inches medially beyond the medial flange.

Another embodiment of the present invention provides a vehicle wheel of the type upon which a tire is mounted, the vehicle wheel including a rim body, a medial flange and a lateral flange together adapted to mount the tire to the rim body, a rim extension extending medially from the rim body beyond the medial flange, and a wheel face that attaches to the rim extension.

The wheel face may include a plurality of spokes, and the plurality of spokes may attach to the rim extension.

### BRIEF DESCRIPTION OF THE DRAWINGS

Novel features in exemplary embodiments of the present invention will be better understood by reference to the following detailed description when considered in conjunction with the accompanying drawings wherein:

FIG. 1 is a front lateral perspective cut-away view of an exemplary embodiment of a rim of the present invention;

FIG. 2 is a front medial perspective view of the rim of FIG. 1;

FIG. 3 is a front cross-sectional view of the rim of FIG. 1;

FIG. 4 is a front cross-sectional view of another exemplary embodiment of a wheel with a rim of the present invention; and

FIG. 5 is a front cross-sectional view of another exemplary embodiment of a wheel with a rim of the present invention.

### DETAILED DESCRIPTION

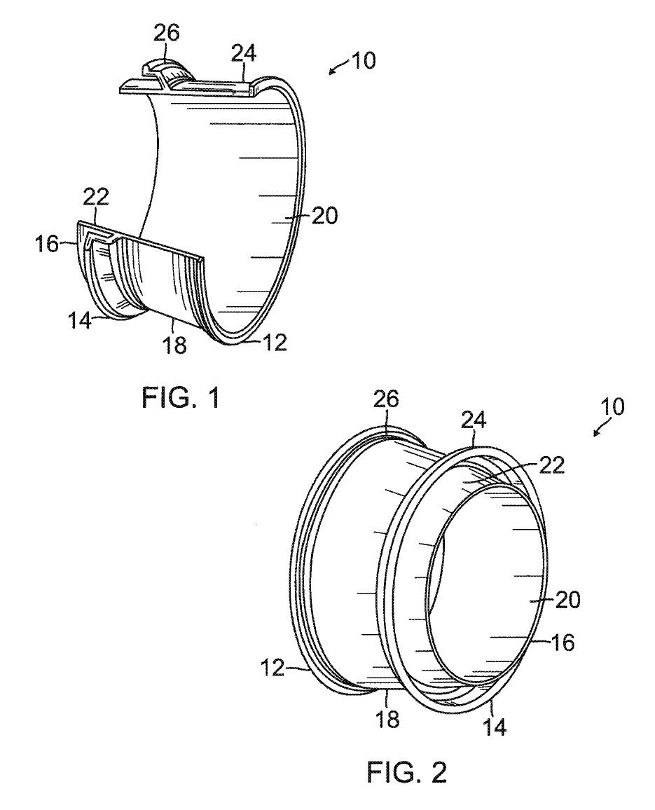

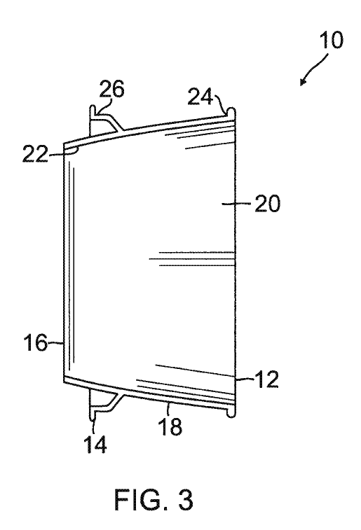

As shown in FIGS. 1-3, the present invention is directed to a vehicle wheel rim having an axially extended inner surface. In one embodiment, the inner surface is extended a distance beyond the inner rim flange to optimize a visual effect, causing the wheel to appear wider from some viewing angles than from other viewing angles.

FIGS. 1-3 show a rim 10 according to an exemplary embodiment of the present invention. In this embodiment, the rim 10 is for an automobile wheel and is designed for being mounted with a tire. As shown, the rim 10 is substantially cylindrical, having an inner surface 20 and an outer surface 18. A substantially circular lateral flange 12 is at a lateral edge of the rim 10, which is towards an exterior of an automobile when installed. Though described as substantially cylindrical, the inner surface 20 may generally conically taper to a circular medial edge 16, which is towards an interior of the automobile when installed. A substantially circular medial flange 14 is on the outer surface 18 of the rim 10 between the lateral flange 12 and the medial edge 16. A rim extension 22 extends from the medial flange 14 to the medial edge 16. For example, the rim extension 22 may extend from about ⅛ inch to about 6 inches beyond the medial flange 14. The rim 10 is formed of a suitable rigid material, such as a metal alloy or other composite materials. A tire (not shown) may be mounted on the rim 10, with the beads of the tire positioned at a lateral bead seat 24 in the lateral flange 12 and a medial bead seat 26 in the medial flange 14.

In general, the line of sight represents the line along which the rim extension 22 may be viewed by one viewing a wheel with the rim extension 22. In one embodiment, the line of sight is such that a person viewing the wheel from the side of the automobile views the rim extension 22 extending axially towards the interior of the automobile and perceives that the wheel is generally wider than the wheel would appear without the rim extension 22. This feature adds an aesthetically pleasing visual depth to the look of the wheel.

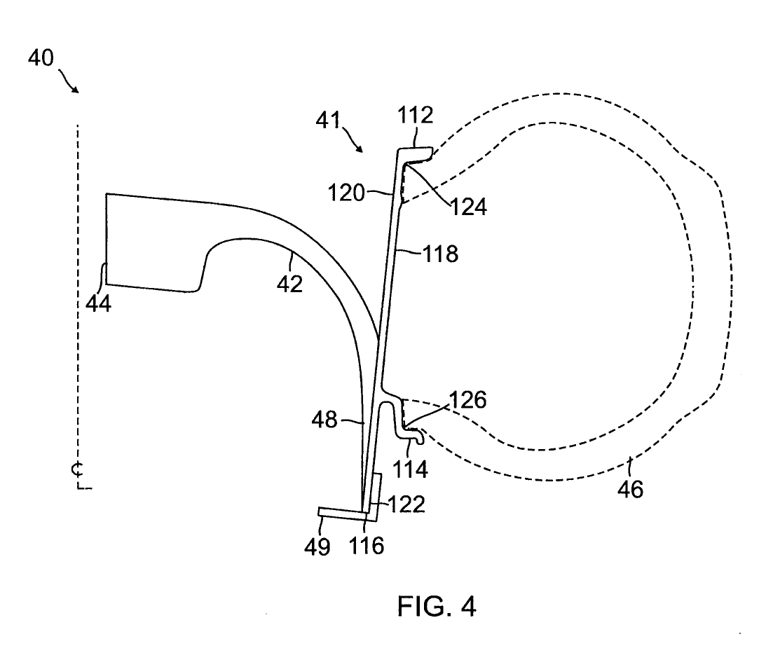

As shown in FIG. 4, the wheel 40 generally includes a wheel face with one or more spokes 42 that extend from a rim body 41 to a hub 44. The spoke 42 may be any suitable shape to attach the rim body 41 to the wheel mounting surface 44, and wheel faces and spoke designs are well known in the art. According to this embodiment, a spoke extension 48 of the spoke 42 attaches to an inner surface 120 of the rim body 41 towards a medial edge 116 of a rim extension 122, which extends from a medial flange 114 to the medial edge 116. Because the spoke extension 48 extends medially beyond the medial flange 114, the visual effect of the viewer perceiving an increased wheel 40 width is further enhanced.

A tire 46 may be mounted on an outer surface 118 of the rim body 41, with the beads of the tire positioned at a lateral bead seat 124 in a lateral flange 112 and a medial bead seat 126 in the medial flange 114. The wheel 40 may be attached to the axle of the automobile at the hub 44 by various means, which are well known by those skilled in the art.

In another embodiment, an optional lip 49 may extend radially inward from the medial edge 116. For example, the lip 49 may extend from about ⅛ inch to about 4 inches radially inward. The lip 49 may be cosmetic or may structurally enhance the wheel 40.

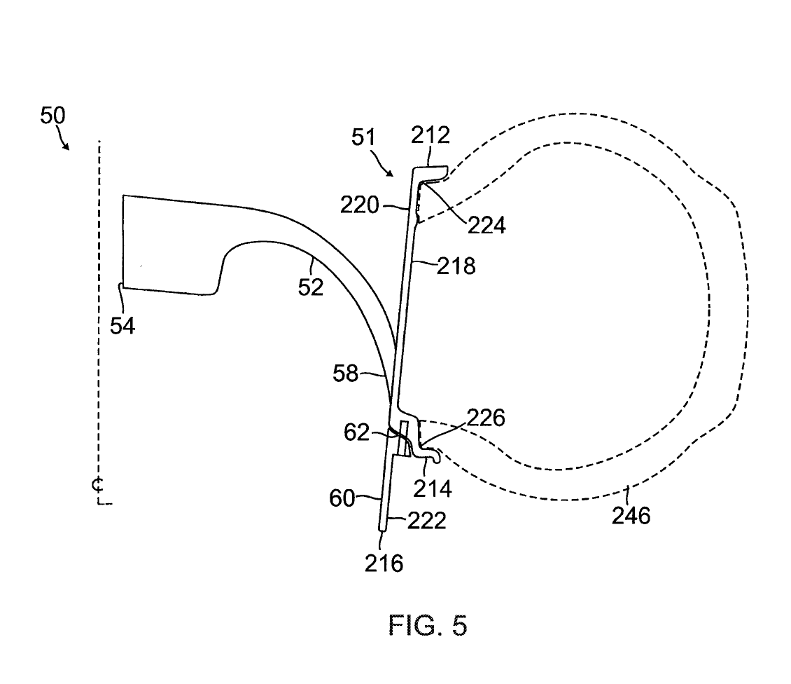

In another embodiment, as shown in FIG. 5, a wheel 50 may have one or more spokes 52 that extend from a rim body 51 to a hub 54. For this embodiment, a spoke extension 58 of the spoke 52 attaches to an inner surface 220 of the rim body 51 towards a medial edge 216. However, rather than being integral to the rim body 51, a rim extension 222 that extends from the medial edge 216 to a medial flange 214 may be attachable at a joint 62 by various means, such as screws or welds. Here, a visual effect of the viewer perceiving the wheel 50 to be wider from some angles is due to the rim extension inner surface 60 extending axially towards the interior of the automobile.

It should be noted that the rim extension inner surface 60 and the inner surface 220 may be configured to give the appearance or illusion of being one smooth continuous part. In particular, in the embodiment of FIG. 5, the rim extension 222 is configured such that when attached at the joint 62, the rim extension inner surface 60 is flush with the inner surface 220. This adds to the appearance or the illusion that the rim extension section 222 and the inner surface 220 are formed as one continuous part.

However, while the rim extension section 222 and the inner surface 220 may be configured to look as if they are a single component, they may also be configured to be clearly separate parts to result in various different visual effects.

A tire 246 may be mounted on an outer surface 218 of the rim 51, with the beads of the tire positioned at a lateral bead seat 224 in a lateral flange 212 and a medial bead seat 226 in the medial flange 214.

Although the inner surface in the depicted embodiments is illustrated as having a smooth curved surface, in other embodiments the inner surface may have flat surfaces, convex surfaces, concave surfaces, contoured surfaces, or any combination thereof. These various surfaces can alter the visual impression of the viewer, thus providing various aesthetically pleasing visual effects.

In another embodiment of the present invention, on a rim of a wheel, some spokes may attach to a rim body and some spokes may attach to a rim extension, thereby enhancing the visual effect increasing the appearance of the width of the wheel. In an embodiment, the spokes attaching to the rim body may alternate with the spokes attaching to the rim extension.

In another embodiment of the present invention, the wheel face may comprise a disc utilized to attach the rim to the hub, in place of the spokes. The disc may have a solid surface or may have various different cut-outs for aesthetic purposes, and may be flat or dished.

The wheel may be produced by any one of many known methods for making wheels, one example being the use of a casting process. In other embodiments of the present invention, the wheel may be formed by a one piece method (where casting or forging occurs at the same time for rim and disc/spokes), a two piece method (where rim and disc/spokes are manufactured separately and later welded or otherwise fastened together), or a three piece method (where both rim flanges and disc/spokes are manufactured separately and later welded or otherwise fastened together). Such manufacturing means are well known in the art.

Furthermore, the wheel can be made of any one of several materials well known in the art of wheel building and design. For example, the inner surface may be a polished metal or plated with a chrome material. In addition, the inner surface may be covered, coated, or plated by a reflective material to produce an overall aesthetically appealing wheel. In another embodiment, the inner surface may be textured, painted, or imprinted with a design.

Although the above description and illustrations described embodiments of the wheel of the present invention as being used on an automobile, in other embodiments the wheel according to the present invention may be used on a truck, a trailer, a motorcycle, or any other appropriate vehicle. In addition, it will be appreciated by those of ordinary skill in the art that the invention can be embodied in other specific forms without departing from the spirit or essential character thereof. The present invention is therefore considered in all respects to be illustrative and not restrictive. The scope of the invention is indicated by the appended claims, and all changes that come within the meaning and range of equivalents thereof are intended to be embraced therein.

What is claimed is:

1. A vehicle wheel of the type upon which a tire is mounted, the vehicle wheel comprising:
a rim body;
a medial flange and a lateral flange together adapted to mount the tire to the rim body; and
a rim extension adapted to extend medially from the rim body beyond the medial flange.

2. The vehicle wheel of claim 1, wherein the rim body and the rim extension are integral to one another.

3. The vehicle wheel of claim 1, wherein the rim body and the rim extension are separate components.

4. The vehicle wheel of claim 1, further comprising a wheel face.

5. The vehicle wheel of claim 4, wherein the wheel face attaches to the rim extension.

6. The vehicle wheel of claim 4, wherein the wheel face attaches to the rim body.

7. The vehicle wheel of claim 1, further comprising a lip that extends radially inward from the rim extension.

8. The vehicle wheel of claim 7, wherein the lip and the rim extension are integral to one another.

9. The vehicle wheel of claim 7, wherein the lip and the rim extension are separate components.

10. A vehicle wheel, of the type upon which a tire is mounted, the vehicle wheel comprising:
a rim body;
a medial flange and a lateral flange together adapted to mount the tire to the rim body;
a wheel face comprising at least one spoke; and
a rim extension adapted to extend medially from the rim body beyond the medial flange.

11. The vehicle wheel of claim 10, wherein the rim body and the rim extension are integral to one another.

12. The vehicle wheel of claim 10, wherein the rim body and the rim extension are separate components.

13. The vehicle wheel of claim 10, wherein the spoke attaches to the rim body at the rim extension.

14. The vehicle wheel of claim 10, wherein multiple spokes attach to the rim body at the rim extension.

15. The vehicle wheel of claim 10, wherein the wheel face attaches via at least one spoke to the rim extension and at least one spoke to the rim body.

16. The vehicle wheel of claim 10, further comprising a lip that extends radially inward from the rim extension.

17. The vehicle wheel of claim 10, the rim extension extends from about ⅛ inch to about 6 inches medially beyond the medial flange.

18. A vehicle wheel of the type upon which a tire is mounted, the vehicle wheel comprising:
a rim body;
a medial flange and a lateral flange together adapted to mount the tire to the rim body;
a rim extension adapted to extend medially from the rim body beyond the medial flange; and
a wheel face that attaches to the rim extension.

19. The vehicle wheel of claim 18, wherein the wheel face comprises a plurality of spokes.

20. The vehicle wheel of claim 19, wherein the plurality of spokes attaches to the rim extension.
